(19) United States
(12) Patent Application Publication
(10) Pub. No.: US 2004/0065307 A1
(43) Pub. Date: Apr. 8, 2004

(54) Fuel injection system and method

(76) Inventors: Scott B. Fiveland, Peoria, IL (US); Joel D. Hiltner, Powell, OH (US)

Correspondence Address: Finnegan, Henderson, Farabow,, Garrett & Dunner, L.L.P., 1300 I Street, N.W., Washington, DC, 20005-3315, US

(21) Appl. No.: 10/263,785

(22) Filed: Oct. 4, 2002

(51) Int. Cl. F02G 5/00

(52) U.S. Cl. 123/552; 123/557

(57) ABSTRACT

A system and method for injecting fuel is provided. The pressure of a flow of fuel is increased to a predetermined pressure. The temperature of the flow of fuel is increased to a predetermined temperature. A flow of intake air is directed into a combustion chamber of an internal combustion engine. The flow of intake air has a pressure lower than the pressure of the flow of fuel. An amount of the pressurized and heated fuel is injected into the flow of intake air to thereby decrease the pressure of the amount of fuel. The decrease in the pressure of the amount of fuel causes the amount of fuel to vaporize.

### TECHNICAL FIELD

The present invention is directed to a fuel injection system and, more particularly, to a system and method for injecting fuel into an engine.

### BACKGROUND

Fuel injection systems are commonly used to deliver fuel to an internal combustion engine, such as, for example, a diesel engine. A fuel injection system commonly includes a series of fuel injectors that inject a certain quantity of fuel to a series of combustion chambers in the engine. The injected fuel mixes with intake air in the combustion chamber. In a diesel engine, the fuel is ignited when an advancing piston increases the pressure of the fuel and air mixture above an ignition temperature and/or pressure for the particular type of diesel fuel. The resulting combustion drives the piston through a combustion stroke, which is translated to an output rotation of a crankshaft. The rotation of the crankshaft may be used to power a generator or to drive a vehicle, which may be, for example, a truck or a work machine.

The operation of the internal combustion engine may, however, generate undesirable emissions, such as, for example, particulates and oxides of nitrogen (NOx). These emissions are undesirable by-products of the fuel combustion process. The engine may be equipped with an emission reduction system, such as, for example, a filter or an exhaust gas recirculation system, to reduce the amount of emissions that are exhausted to the environment.

The amount of emissions generated during fuel combustion may be reduced by improving the combustion conditions within the combustion chamber. For example, achieving an even distribution within the fuel and air mixture may result in a more complete combustion of the fuel. A complete fuel combustion may generate a lower amount of emissions than an incomplete combustion of the fuel.

The mixing of the fuel and air may be enhanced through a number of different approaches. For example, fuel may be injected into the combustion chamber in several short bursts instead of a single longer burst. Alternatively, the fuel may be injected into the intake air flow upstream of the combustion chamber, such as in the intake manifold. In addition, the shape of the piston may be altered to improve the circulation of the intake air entering the combustion chamber to thereby improve the mixing of the fuel and air. Another approach to improving the fuel and air mixing characteristics is to change the state of the fuel from liquid to vapor. Vaporized fuel may mix better with the intake air flow than liquid fuel.

Liquid fuel may be changed to a vapor state by subjecting the fuel to a pressure and/or temperature change that causes the fuel to cross its liquid-vapor line. As described in U.S. Pat. No. 4,703,741 to Curran et al., gasoline may be changed to a gaseous state by superheating the fuel in a heat exchanger that transfers heat from engine exhaust to the gasoline. U.S. Pat. No. 4,703,741 describes heating the gasoline to a temperature of about 371° C. (700° F.) to vaporize the gasoline. The vaporized gasoline may then be mixed with the intake air prior to combustion.

However, diesel fuel may not be superheated in the manner suggested by U.S. Pat. No. 4,703,741. If the diesel fuel were to be superheated, the temperature of the diesel fuel may reach or approach its ignition temperature prior to reaching the combustion chamber. If the diesel fuel were to reach the critical temperature in the heat exchanger, the diesel fuel would ignite in the heat exchanger.

The fuel injection system and method of the present disclosure solves one or more of the problems set forth above.

### SUMMARY OF THE INVENTION

In one aspect, the present invention is directed to a method of injecting fuel. The pressure of a flow of fuel is increased to a predetermined pressure. The temperature of the flow of fuel is increased to a predetermined temperature. A flow of intake air is directed into a combustion chamber of an internal combustion engine. The flow of intake air has a pressure lower than the pressure of the flow of fuel. An amount of the pressurized and heated fuel is injected into the flow of intake air to thereby decrease the pressure of the amount of fuel. The decrease in the pressure of the amount of fuel causes the amount of fuel to vaporize.

In another aspect, the present invention is directed to a fuel injection system that includes a fuel pump operable to pressurize a flow of fuel to a predetermined pressure. A heat exchanger is adapted to transfer heat from a flow of exhaust gas from an engine to the flow of fuel to thereby increase the temperature of the flow of fuel. A fuel injector is connected to the fuel pump and is operable to inject an amount of the pressurized and heated fuel into a flow of intake air having a pressure lower than the predetermined pressure of the flow of fuel. The injection of the amount of fuel causes a pressure drop in the amount of fuel to thereby induce vaporization of the amount of fuel.

### BRIEF DESCRIPTION OF THE DRAWINGS

FIG. 1 is a schematic and diagrammatic representation of a vehicle having a fuel injection system according to an exemplary embodiment of the present invention; and

FIG. 2 is a graph illustrating an exemplary vapor-liquid line for an exemplary diesel fuel.

### DETAILED DESCRIPTION

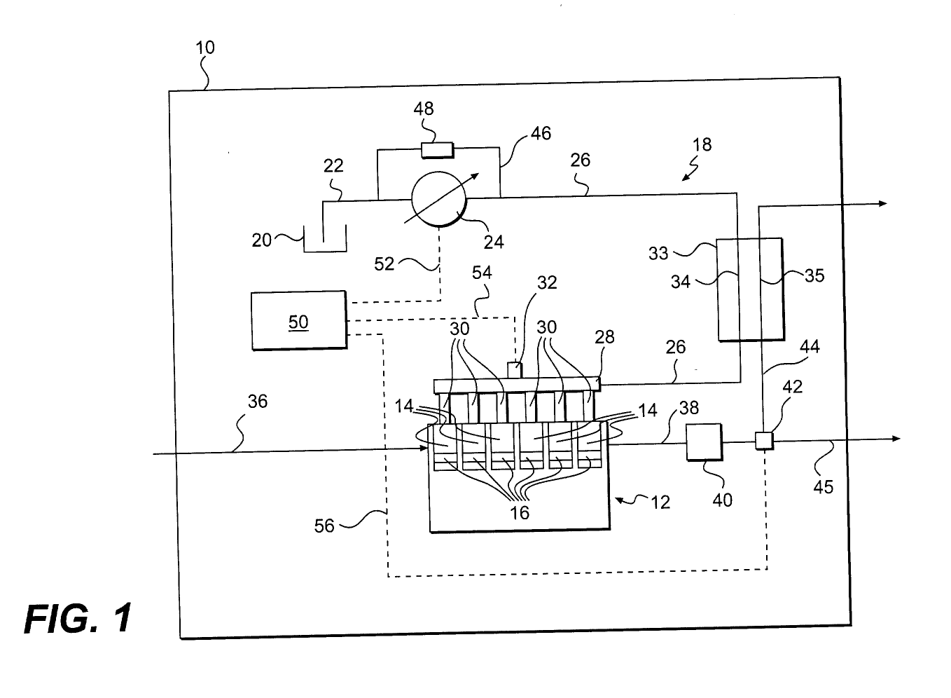

As diagrammatically and schematically illustrated in FIG. 1, a machine, which may be, for example, a vehicle 10 or a power generator, may include an engine 12. Engine 12 may be an internal combustion engine, such as a diesel engine, that includes a series of combustion chambers 14. A piston 16 may be slidably disposed within each combustion chamber 14. Each piston 16 may be further configured to reciprocate between a top-dead-center position and a bottom-dead-center position through an intake stroke, a compression stroke, a combustion stroke, and an exhaust stroke.

Vehicle 10 also includes an intake air passageway 36, which directs intake air into the series of combustion chambers 14. Engine 12 may include an intake manifold (not shown) that directs the intake air into each combustion chamber 14. Engine 12 may further include a series of intake valves (not shown) that are associated with the series of combustion chambers 14. Each intake valve may be selectively opened to allow intake air to flow into the respective combustion chamber 14. Each intake valve may be opened, for example, when piston 16 is moving through the intake stroke.

As also shown in FIG. 1, vehicle 10 may also include an exhaust passageway 38. Exhaust passageway 38 directs exhaust gas from each compression chamber 14. Engine 12 may include an exhaust manifold (not shown) that connects combustion chambers 14 with exhaust passageway 38. Engine 12 may further include a series of exhaust valves (not shown) that may be selectively opened to allow exhaust gases to flow from the respective combustion chamber 14 to exhaust passageway 38. Each exhaust valve may be opened, for example, when piston 16 is moving through an exhaust stroke.

Vehicle 10 may also include one or more performance enhancing devices (not shown). For example, vehicle 10 may include a device, such as, for example, a turbocharger or a supercharger, that is adapted to increase the pressure of the intake air. As one skilled in the art will recognize, this type of device may be operatively engaged with intake air passageway 36 and/or exhaust passageway 38.

In addition, vehicle 10 may include a system or device for reducing the emissions generated during the operation of engine 12. For example, a filter 40 may be disposed in exhaust passageway 38 to remove undesirable emissions, such as, for example, particulates, from the exhaust flow. One skilled in the art will recognize that vehicle 10 may include various other emission reducing devices, such as, for example, exhaust gas recirculation systems, scrubbers, or membranes.

As illustrated in FIG. 1, vehicle 10 also includes a fuel injection system 18. Fuel injection system 18 includes a fuel tank 20 that stores a supply of fuel. The fuel may be any type of fuel commonly used in the operation of an internal combustion engine, such as, for example, gasoline or diesel fuel.

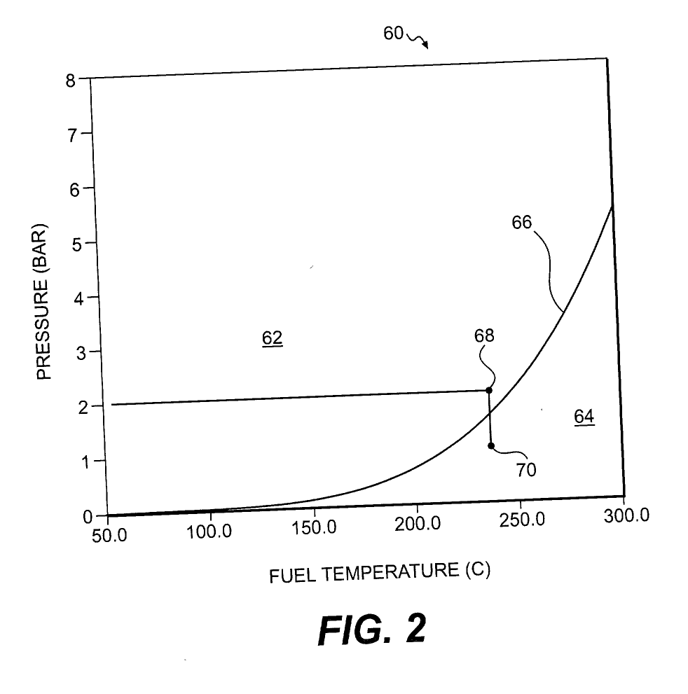

The fuel stored in fuel tank 20 has a set of thermodynamic properties that define the conditions under which the fuel will be in a vapor state and when the fuel will be in a liquid state. FIG. 2 illustrates an exemplary plot 60 of a liquid-vapor curve 66 for n-dodecane fuel. As shown, vapor curve 66 defines the pressures and temperatures at which n-dodecane fuel will change from a liquid state 62 to a vapor state 64. One skilled in the art will recognize that different types of fuel will have different thermodynamic properties and may change from a liquid state to a vapor state at different pressures and/or temperatures.

Fuel injection system 18 may include a fuel pump 24. Fuel pump 24 may draw fuel from fuel tank 20 through a fuel line 22. Fuel pump 24 may increase the pressure of the fuel to a predetermined pressure and direct the pressurized fluid into fuel line 26. Fuel pump 24 may be, for example, a fixed capacity, variable displacement pump. One skilled in the art will recognize, however, that fuel pump 24 may be any other type of pump, such as, for example, a variable capacity pump.

As also shown in FIG. 1, fuel injection system 18 includes a fuel rail 28. Fuel rail 28 is connected to fuel line 26. Fuel rail 28 stores a supply of fuel that is pressurized to the predetermined pressure.

As shown in FIG. 1, a sensor 32 may be operatively engaged with fuel rail 28. Sensor 32 may be operable to sense one or more parameters of the fuel in fuel rail 28. For example, sensor 32 may be configured to sense the pressure and/or temperature of the fuel in fuel rail 28. Additional sensors 32 may be included to sense these or other parameters of the fuel in fuel rail 28.

Fuel injection system 18 may also include a fuel by-pass line 46. Fuel by-pass line 46 may provide a fluid connection between the outlet and inlet of fuel pump 24. A by-pass valve 48 may be disposed in by-pass line 46. By-pass valve 48 may be opened if the pressure of the fuel in fuel line 26 or in fuel rail 28 exceeds a pre-determined limit. Opening by-pass valve 48 will allow fluid to return to fuel tank 20 from fuel rail 28 or fuel line 26 to thereby reduce the pressure. By-pass valve 48 may be, for example, a spring loaded check valve that is configured to open when exposed to a pre-determined pressure differential.

Fuel injection system 18 also includes a series of fuel injectors 30. Each fuel injector 30 is disposed between fuel rail 28 and one combustion chamber 14. Fuel injectors 30 may be operated to selectively inject an amount of fuel from fuel rail 28 into the respective combustion chamber 14. Each fuel injector 30 may inject a certain amount of fuel into the respective combustion chamber 14 when the respective piston 16 is moving through the intake stroke. Alternatively, as one skilled in the art will recognize, fuel injectors 30 may be adapted to inject the amount of fuel upstream of the combustion chamber 14, such as, for example, into a chamber in intake passageway 36.

One skilled in the art will further recognize that any of a variety of types of fuel injectors 30 may be used in fuel injection system 18. Fuel injection system 18 may be a “common rail” type injection system where fuel pump 24 increases the pressure of the fuel to the injection pressure and the fuel injectors release a certain quantity of fuel into the intake air. Alternatively, fuel injectors 30 may be “unit type” injectors, such as, for example, mechanical fuel injectors, mechanically operated and electronically controlled fuel injectors, or hydraulically operated and electronically controlled fuel injectors. With a “unit type” fuel injector, fuel pump 24 increases the pressure of the fluid to a pressure that is less than the injection pressure and the unit injector further increases the pressure of the fuel to the injection pressure before injecting the fuel into the intake air.

As also shown in FIG. 1, vehicle 10 may include a heat exchanger 33. Heat exchanger 33 may be configured to transfer heat from a flow of exhaust gas exiting combustion chambers 14 to a flow of fuel in fuel line 26. The transfer of heat will act to increase the temperature of the flow of fuel in fuel line 26.

Heat exchanger 33 may have any configuration readily apparent to one skilled in the art. For example, heat exchanger 33 may include a first pipe 34 that guides the flow of fuel and a second pipe 35 that guides the flow of exhaust gas. First pipe 34 may be disposed inside of second pipe 35 so that the flow of exhaust gas surrounds the outer surface of the first pipe 34. In this manner, heat from the flow of exhaust gas may be transferred to the flow of fuel to increase the temperature of the flow of fuel.

As shown in FIG. 1, the flow of exhaust gas in exhaust passageway 38 may be split into a first exhaust path 44 and a second exhaust path 45. First exhaust path 44 may direct a portion of the flow of exhaust gas to heat exchanger 33 and then to the environment. Second exhaust path 45 may direct the remaining amount of the flow of exhaust gas directly to the environment.

A valve 42, such as, for example, a variable position valve, may be disposed at the juncture between first exhaust path 44 and second exhaust path 45. The position of valve 42 controls the rate at which exhaust gas flows through first exhaust path 44 to heat exchanger 33. Valve 42 may be adjusted to increase or decrease the rate at which exhaust gas flows through heat exchanger 33. Valve 42 may be any type of valve readily apparent to one skilled in the art, such as, for example, a solenoid operated valve.

As further shown in FIG. 1, vehicle 10 may include a controller 50. Controller 50 may be an electronic control module that includes a microprocessor and memory. As is known to those skilled in the art, the memory may be connected to the microprocessor and may store an instruction set and variables. Associated with the microprocessor and part of the electronic control module may be various other known circuits such as, for example, power supply circuitry, signal conditioning circuitry, and solenoid driver circuitry, among others.

As one skilled in the art will recognize, controller 50 may be programmed to control one or more aspect of the operation of engine 12. For example, controller 50 may be programmed to control the operation of fuel injectors 30 of fuel injection system 18. Controller 50 may control fuel injectors 30 to inject a certain amount of fuel into combustion chambers 14 at a certain time in the operation of engine 12.

In addition, controller 50 may be programmed to control the operation of fuel pump 24 and the position of valve 42. Controller 50 may be connected to fuel pump 24 through a control line 52. Controller 50 may be further connected to valve 42 through a control line 56.

Controller 50 may also be configured to receive informational signals that are indicative of the operating conditions of engine 12 and/or vehicle 10. For example, controller 50 may be connected to sensor 32 through a control line 54. Controller 50 may receive a signal from sensor 32 regarding the pressure and/or temperature of fuel within fuel rail 28. Controller 50 may control the operation of fuel injection system 18, engine 12, and/or vehicle 10 based on the information contained in the informational signals.

### Industrial Applicability

Vehicle 10 may be any type of vehicle that commonly includes an engine 12, such as, for example, an on-highway truck, an off-highway truck, or a work machine. Engine 12 may be operated to provide power for vehicle 10. The power provided by engine 12 may be used to propel vehicle 10 and/or to run one or more auxiliary systems of vehicle 10. One skilled in the art will recognize that engine 12 may be used in various alternative applications, such as, for example, to drive a generator to produce electricity.

When engine 12 is operating, a flow of intake air is directed through intake passageway 36 to the combustion chambers 14 of engine 12. The intake air may be drawn from outside vehicle 10, such as from the environment. The temperature of the intake air should be maintained at a relatively low temperature, such as, for example, less than about 100° C.

The operation of engine 12 generates a flow of exhaust gas that is directed from combustion chambers 14 and into exhaust passageway 38. As a result of the fuel combustion in combustion chambers 14, the exhaust gas will have a high temperature. The flow of exhaust may be directed through filter 40 to valve 42. Filter 40 removes particulates or other debris from the exhaust flow. Valve 42 may be modulated to control the rate at which exhaust flows through each of first exhaust path 44 and second exhaust path 45. The exhaust that does not flow through first exhaust path 44 may be directed through second exhaust path 45 and, ultimately, to the environment.

During the operation of engine 12, fuel pump 24 draws a flow of fuel from fuel tank 20. Fuel pump 24 increases the pressure of the fuel to a pressure greater than the pressure of the flow of intake air. For example, fuel pump 24 may increase the pressure of a diesel fuel to about 200 kPa (2 bar). The pressurized fuel is directed through fuel line 26 towards heat exchanger 33.

The temperature of the pressurized fuel is increased as the fuel flows through heat exchanger 33. The pressurized fluid flows through first pipe 34 and the flow of exhaust flows through second pipe 35. Second pipe 35 may guide the flow of exhaust around the outer surface of first pipe 34, so that heat is transferred from the flow of exhaust to the flow of pressurized fuel. The pressurized fuel exits heat exchanger 33 at an elevated temperature. The temperature of the pressurized fuel may be, for example, between about 200° C. and 250° C.

The heated and pressurized fuel flows to fuel rail 28, which supplies fuel to fuel injectors 30. Fuel injectors 30 may be operated to inject a desired amount of the heated and pressurized fuel into the respective combustion chamber 14 of engine 12. Fuel injectors 30 may inject the fuel into combustion chamber 14 at any point in the operating cycle of the engine 12. For example, the fuel may be injected during the intake stroke of piston 16 or during the first portion of the compression stroke of the piston 16.

The pressure drop associated with the injection of the heated and pressurized fuel into the flow of intake air causes the fuel to vaporize. As shown in FIG. 2, as the fuel leaves heat exchanger 33, the fuel has been heated and pressurized to the liquid state 68. When an amount of the pressurized and heated fuel is injected into the intake air in combustion chamber 14, the pressure of the amount of injected fuel will drop. As the pressure drops, the fuel will cross vapor line 66 and flash to vapor as the pressure of the fuel approaches the vapor state 70.

The vaporized fuel mixes with the intake air as the fuel is injected into combustion chamber 14. The vaporized fuel may be injected into the intake air flow during the intake stroke of piston 16. The movement of the intake air within combustion chamber 14 will enhance the mixing of the vaporized fuel and the air. Accordingly, the fuel may be evenly distributed with the intake air as piston 16 starts the compression stroke.

When the fuel and air mixture is compressed to the critical pressure, the fuel will ignite and drive piston 16 through a combustion stroke. The exhaust gases produced during the combustion process are forced from the combustion chamber 14 as piston 16 moves through an exhaust stroke. The exhaust gases are then directed into exhaust passageway 38. The combustion of the vaporized fuel and air mixture will generate fewer undesirable emissions, such as, for example, particulates and oxides of nitrogen, than the combustion of a liquid fuel and air mixture.

It should be noted that the injection of the heated and pressurized fuel into the flow of intake air may also result in a decrease in the temperature of the fuel. If the decrease in temperature of the fuel occurs quickly, the fuel may flash back to a liquid state. However, it is expected that the time required for the temperature of the fuel to decrease and change the fuel to a liquid state will be greater than the time required to compress and ignite the fuel. Accordingly, the fuel is expected to remain in a vapor state until the fuel is combusted.

The operation of fuel pump 24 and heat exchanger 33 may be monitored and controlled to prevent the pressure and/or temperature of a diesel fuel from approaching the critical point for the particular diesel fuel. The diesel fuel may ignite prematurely if the temperature and/or pressure of the diesel fuel reaches the critical point. For example, for n-dodecane fuel, the critical temperature is 385° C. and the critical pressure is 26.7 MPa (264 atm).

Controller 50 may control the operation of fuel pump 24 to prevent the fuel from approaching the critical pressure. Controller may monitor the pressure of the fuel in fuel rail 28 through information provided by sensor 32. If controller 50 determines that the pressure of the fuel in fuel rail 28 is too high, controller 50 may vary the operation of fuel pump 24 to decrease the pressure of the fuel. In addition, if the pressure of the fuel in fuel rail 28 or fuel line 26 surpasses a predetermined threshold, by-pass valve 48 may open to allow fuel to flow from fuel line 26 to thereby reduce the fuel pressure.

Controller 50 may also control the operation of heat exchanger 33 to prevent the diesel fuel from reaching the critical temperature. Controller 50 may monitor the temperature of the fuel in fuel rail 28 through information provided by sensor 32. If controller 50 determines that the temperature of the fuel is too high, controller 50 may adjust the position of valve 42 to decrease the rate at which exhaust is flowing through heat exchanger 33. If the temperature of the fuel is too low, controller 50 may adjust the position of valve 42 to increase the rate at which exhaust flows through heat exchanger 33.

As will be apparent from the foregoing description, the present disclosure provides a fuel injection system that provides for improved mixing of fuel and intake air. The described fuel injection system manipulates the temperature and pressure of the fuel to change the fuel from a liquid state to a vapor state. The vaporized fuel is injected into a flow of intake a combustion chamber. The vaporized fuel mixes with the intake air and the mixture is combusted. The enhanced mixing characteristics of the vaporized fuel and air reduce the amount of undesirable emissions generated during the combustion process.

It will be apparent to those skilled in the art that various modifications and variations can be made in the disclosed fuel injection system and method without departing from the scope of the present disclosure. Other embodiments of the fuel injection system will be apparent to those skilled in the art from consideration of the specification and practice of the device disclosed herein. It is intended that the specification and examples be considered as exemplary only, with a true scope of the disclosure being indicated by the following claims and their equivalents.

what is claimed is:

1. A method of injecting fuel, comprising:
increasing the pressure of a flow of fuel to a predetermined pressure;
increasing the temperature of the flow of fuel to a predetermined temperature;
directing a flow of intake air into a combustion chamber of an internal combustion engine, the flow of intake air having a pressure lower than the pressure of the flow of fuel; and
injecting an amount of the pressurized and heated fuel into the flow of intake air to thereby decrease the pressure of the amount of fuel, the decrease in pressure of the amount of fuel causing the amount of fuel to vaporize.

2. The method of claim 1, further including directing a flow of exhaust from the combustion chamber of the engine to a heat exchanger to transfer heat from the flow of exhaust to the flow of fuel to thereby increase the temperature of the fuel.

3. The method of claim 2, wherein the temperature of the fuel is increased to between about 200° C. and 250° C.

4. The method of claim 1, wherein the temperature of the intake air is less than about 100° C.

5. The method of claim 2, further including sensing the temperature of the flow of fuel and varying the rate of flow of exhaust to the heat exchanger based on the sensed temperature of the flow of fuel.

6. The method of claim 5, further including increasing the rate of flow of exhaust to the heat exchanger when the sensed temperature of the flow of fuel falls below a predetermined temperature limit.

7. The method of claim 1, wherein the amount of fuel is injected into the combustion chamber of the internal combustion engine.

8. A fuel injection system, comprising:
a fuel pump operable to pressurize a flow of fuel to a predetermined pressure;
a heat exchanger adapted to transfer heat from a flow of exhaust gas from an engine to the flow of fuel to thereby increase the temperature of the flow of fuel; and
a fuel injector connected to the fuel pump and operable to inject an amount of the heated and pressurized fuel into a flow of intake air having a pressure lower than the predetermined pressure of the flow of fuel, the injection of the amount of fuel causing a pressure drop in the amount of fuel thereby inducing vaporization of the amount of fuel.

9. The fuel injection system of claim 8, further including a fuel rail adapted to provide a supply of fuel at the predetermined pressure to the fuel injector.

10. The fuel injection system of claim 9, further including a plurality of fuel injectors in fluid connection with the fuel rail.

11. The fuel injection system of claim 10, wherein each of the fuel injectors are hydraulically operated and electronically controlled and the fuel pump is a fixed capacity variable displacement pump.

12. The fuel injection system of claim 9, further including a sensor operatively connected with the fuel rail, the sensor configured to sense at least one of a fuel pressure and a fuel temperature of the supply of fuel within the fuel rail.

13. The fuel injection system of claim 12, further including a controller operable to adjust the rate of the exhaust flow through the heat exchanger based on the sensed fuel temperature.

14. The fuel injection system of claim 12, further including a controller operable to vary the operation of the fuel pump based on the sensed fuel pressure.

15. The fuel injection system of claim 8, wherein the heat exchanger includes a first pipe adapted to direct the flow of fuel and a second pipe adapted to surround the first pipe and to direct the flow of exhaust around the first pipe to thereby transfer heat from the flow of exhaust to the flow of fuel.

16. The fuel injection system of claim 8, wherein the temperature of the intake air is less than about 100° C.

17. A vehicle, comprising:
an engine having a combustion chamber, an intake passageway adapted to direct a flow of intake air into the combustion chamber, and an exhaust passageway adapted to direct a flow of exhaust gas from the combustion chamber;
a fuel pump operable pressurize a flow of fuel to a predetermined pressure, the predetermined pressure being greater than the pressure of the flow of intake air;
a heat exchanger adapted to transfer heat from the flow of exhaust gas to the flow of fuel to thereby increase the temperature of the flow of fuel; and
a fuel injector operable to inject an amount of the pressurized and heated fuel into the flow of intake air, the injection of the amount of fuel causing a pressure drop in the amount of fuel thereby inducing vaporization of the amount of fuel.

18. The vehicle of claim 17, further including a plurality of fuel injectors and wherein the engine includes a plurality of combustion chambers, each of the plurality of fuel injectors being adapted to inject an amount of the pressurized and heated fuel into one of the plurality of combustion chambers.

19. The vehicle of claim 18, further including a fuel rail adapted to provide a supply of fuel at the predetermined pressure to the fuel injector.

20. The vehicle of claim 19, further including a sensor operatively connected with the fuel rail and configured to sense at least one of a fuel pressure and a fuel temperature of the supply of fuel within the fuel rail.

21. The vehicle of claim 20, wherein the exhaust passageway includes a first path connecting the combustion chamber with the heat exchanger, a second path connecting the combustion chamber with the environment, and a valve operable to control the rate of exhaust flow through the first path.

22. The vehicle of claim 21, further including a controller operable to adjust the position of the valve to thereby control the rate of exhaust flow through the first path based on the sensed temperature of fuel within the fuel rail.
